(19) United States
(12) Patent Application Publication
(10) Pub. No.: US 2009/0273759 A1
(43) Pub. Date: Nov. 5, 2009

(54) PROJECTION IMAGE DISPLAY APPARATUS

(75) Inventors: Naoyuki Ikeda, Osaka (JP); Ryoko Kubo, Osaka (JP); Keiji Yuyama, Himeji-shi (JP); Nobuyuki Ohsumi, Himeji-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/431,268

(22) Filed: Apr. 28, 2009

(30) Foreign Application Priority Data
Apr. 30, 2008 (JP) 2008-119129

(51) Int. Cl. G03B 21/28

(52) U.S. Cl. 353/20; 353/28

(57) ABSTRACT

A projection image display apparatus includes: an image light generator; a projection optics including a reflection mirror; and a polarization adjusting device adjusting image light to light polarized in a direction substantially orthogonal to a vertical plane along with a traveling direction of the image light reflected by the reflection mirror.

### CROSS REFERENCE TO RELATED APPLICATIONS

This application is based upon and claims the benefit of priority from prior Japanese Patent Application No. 2008-119129, filed on Apr. 30, 2008; the entire contents of which are incorporated herein by reference.

### BACKGROUND OF THE INVENTION

1. Field of the Invention

The present invention relates to a projection image display apparatus which includes a projection optics projecting image light.

2. Description of the Related Art

Heretofore, there has been known a projection image display apparatus which includes an imager modulating light emitted from a light source, and a projection lens projecting light emitted from the imager on a projection surface (screen).

In order to display a magnified image on the screen, a distance between the projection lens and the screen needs to be long. To make this possible, a projection display system has been proposed that is designed to shorten a distance between a projection image display apparatus and a screen by using a reflection mirror reflecting light emitted through a projection lens, onto the screen (for example, see Japanese Patent Publication No. 2006-235516 (Claim 1, FIG. 1 etc.)).

When an attempt is made to shorten the distance between the projection image display apparatus and the screen, the projection image display apparatus inevitably comes closer to the screen and consequently comes into the user's view. To avoid this, projection needs to be performed obliquely from above, below, or a side of the screen. For example, in the projection display system described above, an imager and a projection optics are shifted relative to each other in the vertical direction, and a concave mirror is used as the reflection mirror, in order to shorten the projection distance and perform the oblique projection.

Meanwhile, as a new installation/projection method of the projection image display apparatus, which is designed to shorten the projection distance, conceivable is, for example, a method of installing the projection image display apparatus on a floor or a desk and projecting an object on the floor or the desk. However, not much attention is paid to how and in what occasion such a new installation/projection method can be used.

### SUMMARY OF THE INVENTION

A first aspect of the present invention provides a projection image display apparatus including: an image light generator (image light generator 200) configured to generate image light; and a projection optics (projection optics 300) configured to project the image light on a projection surface (projection surface 210) formed of a water surface. The projection optics includes a reflection mirror (reflection mirror 320) configured to reflect the image light emitted from the image light generator. The projection image display apparatus further includes a polarization adjuster (polarization adjusting device 60) configured to adjust the image light to polarized light on the projection surface, the polarized light being polarized in a direction substantially orthogonal to a vertical plane along with a traveling direction of the image light reflected by the reflection mirror.

According to the first aspect, the polarization adjuster adjusts the image light to the light polarized in the direction substantially orthogonal to the vertical plane along with the traveling direction of the image light reflected by the reflection mirror. In other words, the polarization adjuster adjusts the image light to s-polarized light on the projection surface. This makes it possible to effectively display the image on the projection surface formed of the water surface.

In the first aspect, the image light generator further includes a color combining unit (cross dichroic prism 50) configured to reflect first and second color light beams toward the projection optics, and to transmit a third color light beam to the projection optics side. Here, a polarization direction of the first and second color light beams reflected by the color combining unit is different from a polarization direction of the third color light beam transmitted through the color combining unit. Furthermore, the polarization adjuster includes a narrow-band retardation film (polarization adjusting device 70) provided on a light-emitting side of the color combining unit. Still furthermore, the narrow-band retardation film adjusts a polarization direction of a light beam having a part of waveband among the light beams of the image light emitted from the color combining unit.

In the first aspect, the projection image display apparatus further includes a protective cover (protective cover 400a) provided in an optical path of the image light reflected by the reflection mirror. The protective cover includes a transmissive region (transmissive region 410) through which the image light is transmitted. Furthermore, the reflection mirror concentrates the image light emitted from the image light generator between the reflection mirror and the projection surface. The transmissive region is arranged in the vicinity of a position where the image light is concentrated by the reflection mirror.

In the above aspect, at least a part of the protective cover is formed of a light transmissive member, and the transmissive region is formed of the light transmissive member.

### BRIEF DESCRIPTION OF THE DRAWINGS

FIG. 1 is a view showing a projection image display apparatus 100 according to a first embodiment of the present invention.

FIG. 2 is a view showing a configuration of an image light generator 200 according to the first embodiment.

FIG. 3 is a view showing polarization of image light on a projection surface 210 according to the first embodiment.

FIG. 4 is a view showing a configuration of an image light generator 200 according to a second embodiment of the present invention.

### DESCRIPTION OF THE PREFERRED EMBODIMENTS

A projection image display apparatus according to embodiments of the present invention will be described below with reference to the drawings. In the following description of the drawings, the same or similar parts will be denoted by the same or similar reference numerals.

However, it should be noted that the drawings are schematic and that proportions of dimensions and the like are different from actual ones. Thus, specific dimensions and the like should be determined by referring to the following description. Naturally, there are portions where relations or proportions of dimensions between the drawings are different.

### First Embodiment

### (Configuration of Projection Image Display Apparatus)

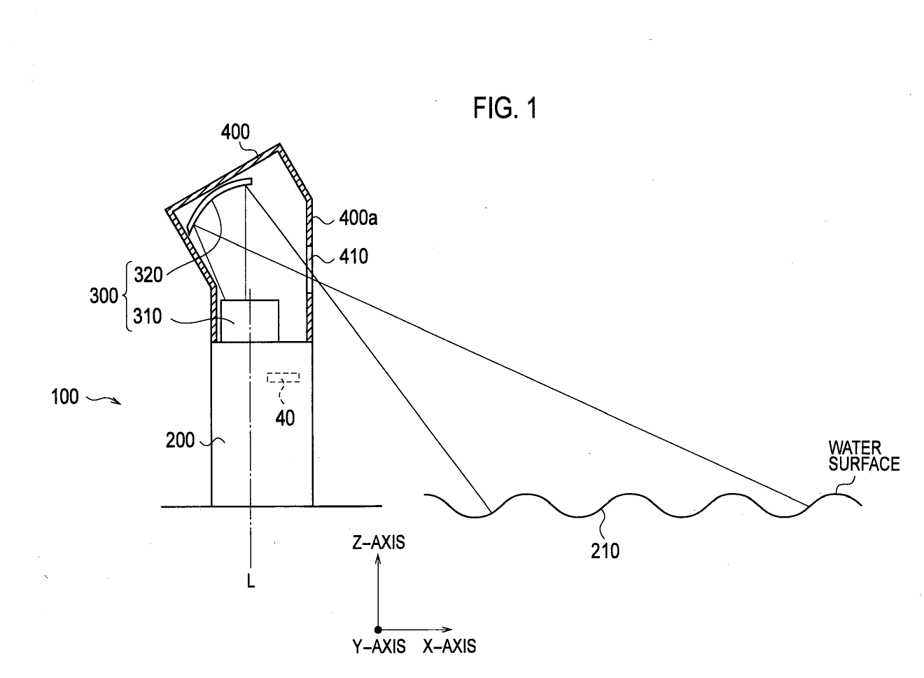

A configuration of a projection image display apparatus according to a first embodiment of the present invention will be described below with reference to the drawings. FIG. 1 is a view showing a configuration of a projection image display apparatus 100 according to the first embodiment.

As shown in FIG. 1, the projection image display apparatus 100 includes a housing 400 which houses an image light generator 200 and a projection optics 300. In the first embodiment, a part of the housing 400 constitutes a protective cover 400a.

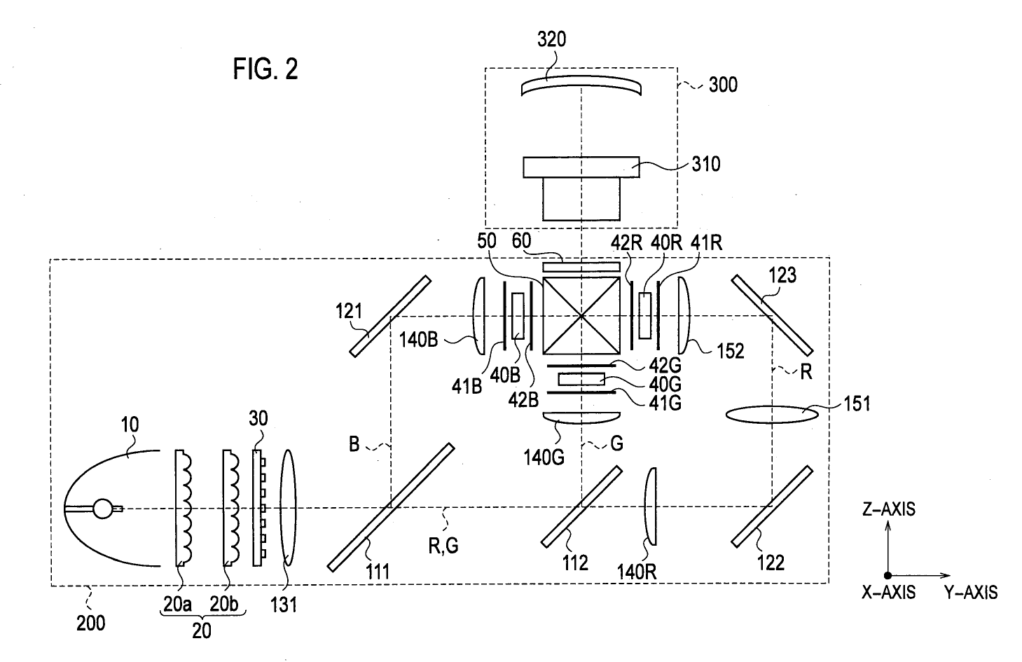

The image light generator 200 generates image light. Specifically, the image light generator 200 includes at least a display device 40 emitting the image light. The display device 40 is provided in a position shifted relative to an optical axis L of the projection optics 300. This shifted arrangement enables oblique projection. A reflective liquid crystal panel, a transmissive liquid crystal panel, a digital micromirror device (DMD), or the like can be used for the display device 40, for example. The image light generator 200 will be described in detail later (See FIG. 2).

The projection optics 300 projects the image light emitted from the image light generator 200 on a projection surface 210. Considered in the first embodiment is a case where the projection surface 210 is formed of a water surface. Specifically, the projection optics 300 includes a projection lens 310 and a reflection mirror 320.

The projection lens 310 emits the image light emitted from the image light generator 200 toward the reflection mirror 320.

The reflection mirror 320 reflects the image light emitted from the projection lens 310. The reflection mirror 320 concentrates and then magnifies the image light. The reflection mirror 320 is, for example, an aspheric mirror having a concave surface on the image light generator 200 side thereof.

The protective cover 400a protects the reflection mirror 320. The protective cover 400a is provided at least in an optical path of the image light reflected by the reflection mirror 320. The protective cover 400a includes a transmissive region 410 transmitting the image light.

In the first embodiment, an X-axis, a Y-axis and a Z-axis are substantially orthogonal to one another. As shown in FIG. 1, the water surface (projection surface 210) is defined by the X-axis and the Y-axis; a traveling direction of the image light reflected by the reflection mirror 320 is defined by the X-axis; a vertical direction substantially orthogonal to the water surface is defined by the Z-axis.

As described above, the projection optics 300 projects the image light transmitted through the transmissive region 410 onto the projection surface 210. As will be described later, the image light is adjusted to polarized light on the projection surface 210, the polarized light being polarized in a direction substantially orthogonal to a vertical plane (namely, X-Z plane) along with the traveling direction of the image light reflected by the reflection mirror 320 (namely, the polarized light in the Y-axis direction).

### (Configuration of Image Light Generator)

A configuration of the image light generator according to the first embodiment will be described below with reference to the drawings. FIG. 2 is a view mainly showing the image light generator 200 according to the first embodiment. Note that the image light generator 200 includes, in addition to the configuration shown in FIG. 2, a power supply circuit (not shown), an image signal processing circuit (not shown), and the like. Here, a case where the display device 40 is a transmissive liquid crystal display panel will be illustrated (hereinafter, the display device 40 will be also referred to as a liquid crystal panel 40).

The image light generator 200 includes a light source 10, a fly-eye lens unit 20, a PBS array 30, multiple liquid crystal panels 40 (a liquid crystal panel 40R, a liquid crystal panel 40G, and a liquid crystal panel 40B), a cross dichroic prism 50, and a polarization adjusting device 60.

The image light generator 200 also includes a mirror group (a dichroic mirror 111, a dichroic mirror 112, reflection mirrors 121 to 123) and a lens group (a condenser lens 131, a condenser lens 140R, a condenser lens 140G, a condenser lens 140B, and relay lenses 151 and 152).

The light source 10 is, for example, an ultra-high pressure mercury lamp (UHP lamp) formed of a burner and a reflector. Light emitted from the light source 10 includes red, green and blue light components.

The fly-eye lens unit 20 equalizes the light emitted from the light source 10. In other words, the fly-eye lens unit 20 equalizes the amounts of light emitted from a central portion of the light source 10 and light emitted from a peripheral portion thereof. Specifically, the fly-eye lens unit 20 is formed of a fly-eye lens 20a and a fly-eye lens 20b.

Each of the fly-eye lens 20a and the fly-eye lens 20b is formed of multiple microlenses. The light emitted from the light source 10 is guided by the microlenses to be incident on the whole surface of each display device 40.

The PBS array 30 aligns polarization directions of the light emitted from the fly-eye lens unit 20. In the first embodiment, the PBS array 30 aligns the light emitted from the fly-eye lens unit 20 in the Z-axis direction.

Of the light emitted from the PBS array 30, the dichroic mirror 111 transmits red and green light beams, and reflects a blue light beam.

Of the red and green light beams transmitted through the dichroic mirror 111, the dichroic mirror 112 transmits the red light beam, and reflects the green light beam.

The reflection mirror 121 reflects the blue light beam to guide the blue light beam to the liquid crystal panel 40B. The reflection mirrors 122 and 123 reflect the red light beam to guide the red light beam to the liquid crystal panel 40R.

The condenser lens 131 concentrates the white light emitted from the light source 10.

The condenser lens 140R makes the red light beam a substantially parallel beam so that the red light beam can be incident on the liquid crystal panel 40R; the condenser lens 140G makes the green light beam a substantially parallel beam so that the green light beam can be incident on the liquid crystal panel 40G; the condenser lens 140B makes the blue light beam a substantially parallel beam so that the blue light beam can be incident on the liquid crystal panel 40B.

The relay lenses 151 and 152 form an approximate image of the red light beam on the liquid crystal panel 40R while suppressing expansion of the red light beam.

The liquid crystal panel 40R modulates the red light beam by rotating the polarization direction of the red light beam. On the light-incident-surface side of the liquid crystal panel 40R, a light-incident-side polarizing plate 41R is provided. The light-incident-side polarizing plate 41R transmits a red light component polarized in one direction (here, light polarized in the Z-axis direction) and shields light, in the red light beam, polarized in the other direction (here, light polarized in the X-axis direction). Meanwhile, on the light-emitting-surface side of the liquid crystal panel 40R, a light-emitting-side polarizing plate 42R is provided. The light-emitting-side polarizing plate 42R shields a red light component polarized in one direction (here, the light polarized in the Z-axis direction) and transmits light, in the red light beam, polarized in the other direction (here, the light polarized in the X-axis direction).

Similarly, the liquid crystal panel 40B modulates the blue light beam by rotating the polarization direction of the blue light beam. On the light-incident-surface side of the liquid crystal panel 40B, a light-incident-side polarizing plate 41B is provided. The light-incident-side polarizing plate 41B transmits a blue light component polarized in one direction (here, light polarized in the Z-axis direction) and shields light, in the blue light beam, polarized in the other direction (here, light polarized in the X-axis direction). Meanwhile, on the light-emitting-surface side of the liquid crystal panel 40B, a light-emitting-side polarizing plate 42B is provided. The light-emitting-side polarizing plate 42B shields light, in the blue light beam, polarized in one direction (here, the light polarized in the Z-axis direction) and transmits a blue light component polarized in the other direction (here, the light polarized in the X-axis direction).

Further, the liquid crystal panel 40G modulates the green light beam by rotating the polarization direction of the green light beam. On the light-incident-surface side of the liquid crystal panel 40G, a light-incident-side polarizing plate 41G is provided. The light-incident-side polarizing plate 41G transmits a green light component polarized in one direction (here, light polarized in the Y-axis direction) and shields light, in the green light beam, polarized in the other direction (here, light polarized in the X-axis direction). Meanwhile, on the light-emitting-surface side of the liquid crystal panel 40G, a light-emitting-side polarizing plate 42G is provided. The light-emitting-side polarizing plate 42G shields light, in the green light beam, polarized in one direction (here, the light polarized in the Y-axis direction) and transmits a green light component polarized in the other direction (here, the light polarized in the X-axis direction).

The cross dichroic prism 50 synthesizes the light beams emitted from the liquid crystal panels 40R, 40G and 40B. Then, the cross dichroic prism 50 emits the light (image light) thus synthesized, to the projection lens 310 side.

Here, the image light emitted from the cross dichroic prism 50 is the light having been transmitted through the light-emitting-side polarizing plates 42R, 42G and 42B respectively provided on the light incident sides of the liquid crystal panels 40R, 40G and 40B. Accordingly, it should be noted that the image light emitted from the cross dichroic prism 50 is polarized in the X-axis direction.

The polarization adjusting device 60 adjusts the image light to light polarized in a direction substantially orthogonal to a vertical plane (namely, X-Z plane) (in short, light polarized in the Y-axis direction), the vertical plane being a plane along with a traveling direction of the image light reflected by the reflection mirror 320. The polarization adjusting device 60 is, for example, a half-retardation film adjusting light polarized in the X-axis direction to light polarized in the Y-axis direction.

### (Polarization of Image Light)

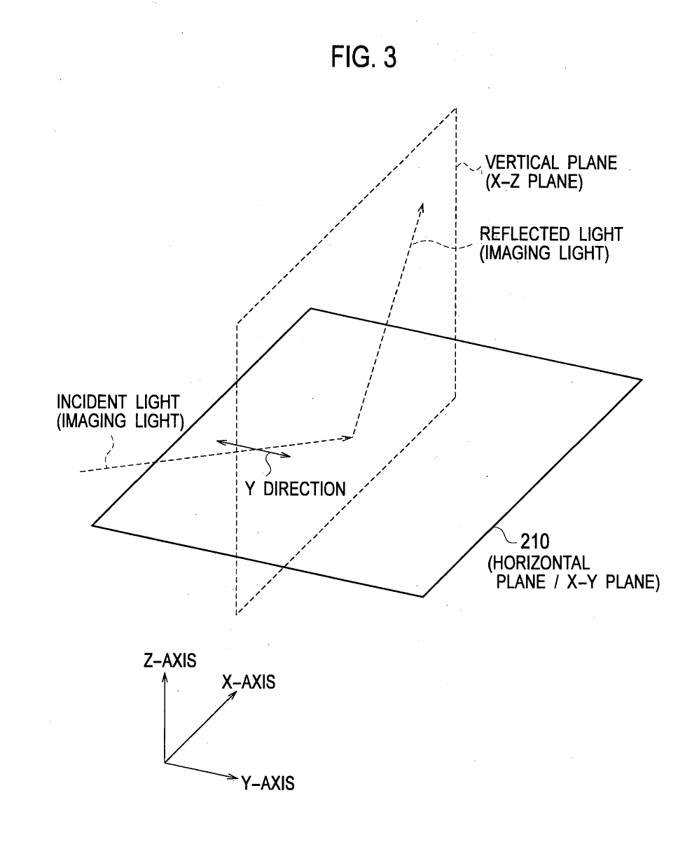

The polarization of the image light emitted from the projection optics according to the first embodiment will be described below with reference to the drawings. FIG. 3 is a view showing the polarization of the image light on the projection surface 210.

As described above, the water surface (projection surface 210) is defined by the X-axis and Y-axis. The traveling direction of the image light reflected by the reflection mirror 320 is defined by the X-axis. A vertical direction substantially orthogonal to the water surface is defined by the Z-axis.

As shown in FIG. 3, the projection surface 210 is provided on the water surface (namely, X-Y plane). The vertical plane (namely, the X-Z plane) is defined by incident light (image light) incident on the projection surface 210 and reflected light (image light) reflected by the projection surface 210.

The image light is adjusted, by the polarization adjusting device 60, to the light polarized in the direction substantially orthogonal to the vertical plane (namely, the X-Z plane) (in short, the light polarized in the Y-axis direction). In other words, the image light includes s-polarized light on the projection surface 210.

### (Advantages and Effects)

In the first embodiment, the protective cover 400a is provided in the optical path of the image light reflected by the reflection mirror 320. This prevents the user from changing the angle of the reflection mirror 320 and the like by touching the reflection mirror 320. Further, the protective cover 400a includes the transmissive region 410 through which the image light reflected by the reflection mirror 320 is transmitted. Accordingly, the image light to be incident on the projection surface 210 is never blocked by the protective cover 400a. In this way, the protective cover 400a avoids displacement of the reflection mirror 320 accurately arranged to shorten a distance between the projection image display apparatus 100 and the projection surface 210.

The polarization adjusting device 60 adjusts the image light to the light polarized in the direction substantially orthogonal to the vertical plane (namely, the X-Z plane) (in short, the light polarized in the Y-axis direction). In other words, the polarization adjusting device 60 adjusts the image light to the s-polarized light on the projection surface 210 formed of the water surface. The adjustment of the image light to the s-polarized light enables effective display of the image on the projection surface 210 formed of the water surface.

Conceivable water surfaces forming the projection surface 210 include, for example, a water surface of water stored in a pool and a water surface of water flowing down a wall.

### Second Embodiment

A second embodiment of the present invention will be described below with reference to the drawings. In the following description, differences between the first and second embodiments will be mainly described.

Specifically, considered in the second embodiment is a case where polarization directions of image light beams of image light emitted from a cross dichroic prism 50 are not uniform.

(Configuration of Image light Generator)

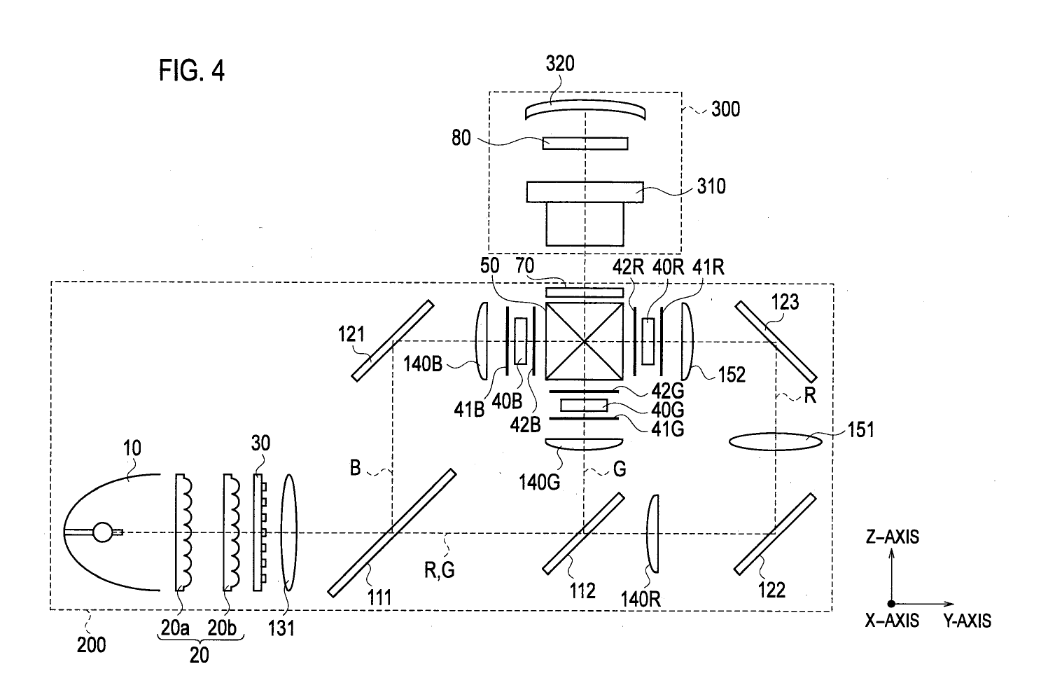

A configuration of an image light generator according to the second embodiment will be described below with reference to the drawings. FIG. 4 is a view mainly showing an image light generator 200 according to the second embodiment. Note that, in FIG. 4, the parts having the same configurations as those of FIG. 2 will be denoted by the same reference numerals.

As shown in FIG. 4, the image light generator 200 includes a polarization adjusting device 70 in place of the polarization adjusting device 60. The projection optics 300 includes a polarization adjusting device 80.

In FIG. 4, considered is a case where a polarization direction of red and blue light beams and a polarization direction of a green light beam are not uniform when the light beams are emitted from the cross dichroic prism 50. For example, the red and blue light beams respectively emitted from the light-emitting-side polarizing plate 42R and the light-emitting-side polarizing plate 42B are polarized in the X-axis direction due to reflection characteristics of the cross dichroic prism 50. Meanwhile, the green light beam emitted from the light-emitting-side polarizing plate 42G is polarized in the Y-axis direction due to transmission characteristics of the cross dichroic prism 50.

The polarization adjusting device 70 is a narrow-band retardation film which adjusts a polarization direction of a light beam having a part of waveband among the image light beams of the image light emitted from the cross dichroic prism 50. For example, the polarization adjusting device 70 adjusts the polarization direction of the green light beam from the Y-axis direction to the X-axis direction, without adjusting the polarization direction of the red and blue light beams. Alternatively, the polarization adjusting device 70 may adjust the polarization direction of the red and blue light beams from the X-axis direction to the Y-axis direction, without adjusting the polarization direction of the green light beam.

The polarization adjusting device 80 is a half-retardation film as the polarization adjusting device 60. The polarization adjusting device 80 adjusts the polarization direction of the image light aligned in the X-axis direction to the Y-axis direction. Note, however, that the polarization adjusting device 80 is not necessary when the polarization direction of the image light is adjusted to the Y-axis direction beforehand by the polarization adjusting device 70.

The polarization adjusting device 80 is provided on the light-emitting side of the projection lens 310; however, the arrangement of the polarization adjusting device 80 is not limited to this. The polarization adjusting device 80 may be provided on the light-incident side or the light-emitting side of the polarization adjusting device 70 in the image light generator 200.

### ADVANTAGES AND EFFECTS

In the second embodiment, the polarization adjusting device 70 adjusts the polarization direction of the light beam having the part of waveband among the image light beams of the image light emitted from the cross dichroic prism 50. This enables the image light to be adjusted to the s-polarized light on the projection surface 210 formed of the water surface, even in the case where the polarization directions of the image light beams of the image light emitted from the cross dichroic prism 50 are not uniform.

### Other Embodiments

The present invention has been described by the above-described embodiments. However, it should be understood that the description and drawings constituting one part of this disclosure do not limit the present invention. Various alternative embodiments, examples, and operational techniques will be apparent from this disclosure for those skilled in the art.

While not particularly described in the above embodiments, at least a part of the protective cover 400a may be formed of a light transmissive member such as a transparent resin or glass. The transmissive region 410 may be formed of such a light transmissive member.

While not particularly described in the above embodiments, the reflection mirror 320 concentrates the image light emitted from the image light generator 200 between itself and the projection surface 210. The transmissive region 410 is preferably provided in the vicinity of a position where the image light is concentrated by the reflection mirror 320.

In the above embodiments, the case where the aspheric mirror is used for the reflection mirror 320 has been illustrated. However, the reflection mirror 320 is not limited to this. Alternatively, a free curve mirror may be used for the reflection mirror 320. Still alternatively, a spheric mirror may also be used for the reflection mirror 320 if aberration and resolution thereof are thoughtfully designed.

In the above embodiments, the case where the multiple display devices 40 are used in the configuration of the image light generator 200 (three-plate type) has been illustrated. However, the configuration of the image light generator 200 is not limited to this. Alternatively, a single display device 40 may be used in the configuration of the image light generator 200 (single-plate type).

In the first embodiment, the polarization adjuster is formed of the polarization adjusting device 60. In the second embodiment, the polarization adjuster is formed of the polarization adjusting device 70 and the polarization adjusting device 80. However, the configuration of the polarization adjuster is not limited to these. Alternatively, the polarization adjuster may have a configuration in which a quarter-retardation film, a half-retardation film and a narrow-band retardation film are appropriately combined. For example, in the first embodiment, a pair of quarter-retardation films may be provided in optical paths of image light incident on the reflection mirror 320 and of image light reflected by the reflection mirror 320.

According to the above embodiments, the distance between the projection image display apparatus 100 and the projection surface 210 is shortened by providing the reflection mirror 320. This makes it possible: to prevent image light from being blocked by a person or thing coming between the projection image display apparatus 100 and the projection surface 210; and to reduce the possibility of irradiating a person with laser light (image light) when LD is used for the light source 10.

What is claimed is:

1. A projection image display apparatus comprising:
an image light generator configured to generate image light;
a projection optics configured to project the image light on a projection surface formed of a water surface; and
a polarization adjuster configured to adjust the image light, wherein
the projection optics includes a reflection mirror configured to reflect the image light emitted from the image light generator, and
the polarization adjuster adjusts the image light to polarized light on the projection surface, the polarized light being polarized in a direction substantially orthogonal to a vertical plane along with a traveling direction of the image light reflected by the reflection mirror.

2. The projection image display apparatus according to claim 1, wherein the image light generator further includes a color combining unit configured to reflect first and second color light beams toward the projection optics, and to transmit a third color light beam to the projection optics,
a polarization direction of the first and second color light beams reflected by the color combining unit is different from a polarization direction of the third color light beam transmitted through the color combining unit,
the polarization adjuster includes a narrow-band retardation film provided on a light-emitting side of the color combining unit, and
the narrow-band retardation film adjusts a polarization direction of a light beam having a part of waveband among the light beams of the image light emitted from the color combining unit.

3. The projection image display apparatus according to claim 1, further comprising a protective cover provided in an optical path of the image light reflected by the reflection mirror, wherein
the protective cover includes a transmissive region through which the image light is transmitted,
the reflection mirror concentrates the image light emitted from the image light generator between the reflection mirror and the projection surface, and
the transmissive region is arranged in the vicinity of a position where the image light is concentrated by the reflection mirror.

4. The projection image display apparatus according to claim 3, wherein
at least a part of the protective cover is formed of a light transmissive member, and
the transmissive region is formed of the light transmissive member.
